(19) United States
(12) Patent Application Publication
(10) Pub. No.: US 2009/0197132 A1
(43) Pub. Date: Aug. 6, 2009

(54) FUEL-CELL STRUCTURE

(75) Inventors: Yu-Chih Lin, Taoyuan County (TW); Chien-Pin Hsu, Taoyuan County (TW); Chih-Yen Lin, Taoyuan County (TW); Yu-Chun Ko, Taoyuan County (TW); Chiang-Wen Lai, Taoyuan County (TW)

Correspondence Address: QUINTERO LAW OFFICE, PC, 2210 MAIN STREET, SUITE 200, SANTA MONICA, CA, 90405, US

(73) Assignee: NAN YA PCB CORP., TAOYUAN COUNTY (TW)

(21) Appl. No.: 12/131,738

(22) Filed: Jun. 2, 2008

(30) Foreign Application Priority Data
Jan. 31, 2008 (TW) TW97103666

(51) Int. Cl. H01M 8/04

(52) U.S. Cl. 429/22; 429/34

(57) ABSTRACT

A fuel-cell structure is provided. The fuel-cell structure includes a base, at least one cell unit, a first supplier, a second supplier and a third supplier. The cell unit disposed on the base includes a reaction region, a first connecting port and an outputting terminal, wherein the first connecting port and the outputting terminal are coupled to the reaction region. The first supplier provides a first fluid transmitted to the reaction region of the cell unit via the first connecting port of the cell unit. The second supplier provides a second fluid transmitted to the reaction region of the cell unit, wherein the second fluid and the first fluid are reacted with respect to the reaction region of the cell unit, so that the reaction region of the cell unit provides a first electric power outputting through the outputting terminal. The third supplier provides a third fluid transmitted to the reaction region of the cell unit via the first connecting port of the cell unit, to humidify the cell unit by the third fluid.

### CROSS REFERENCE TO RELATED APPLICATIONS

This Application claims priority of Taiwan Patent Application No. 97103666 filed on Jan. 31, 2008, the entirety of which is incorporated by reference herein.

### BACKGROUND OF THE INVENTION

1. Field of the Invention

The invention relates to a fuel-cell structure, and more particularly to a planner fuel-cell structure utilized to humidify fuel for an anode and provide fuel to cathode by air breath.

2. Description of the Related Art

Stacked fuel cells of a conventional fuel-cell structure can supply required electric power. However, due to a sprue plate of an anode and a cathode thereof being made of graphite, a sufficient pressure is required to supply fuel by the cathode. As a result, the stacked fuel cells of a conventional fuel-cell structure have a complicated systematic configuration and increased costs. Furthermore, it is difficult for the anode to humidify the fuel by high-temperature water vapors.

### BRIEF SUMMARY OF THE INVENTION

The invention provides an air breathe and planner fuel-cell structure to periodically perform a humidifying process and to continuously supply electric power to electronic devices. An embodiment of the fuel-cell structure comprises a base, at least one cell unit, a first supplier, a second supplier and a third supplier.

The cell unit disposed on the base comprises a reaction region, a first connecting port and an outputting terminal, wherein the first connecting port and the outputting terminal are coupled to the reaction region. The first supplier provides a first fluid transmitted to the reaction region of the cell unit via the first connecting port of the cell unit. The second supplier provides a second fluid transmitted to the reaction region of the cell unit, wherein the second fluid and the first fluid are reacted with respect to the reaction region of the cell unit, so that the reaction region of the cell unit provides a first electric power for outputting through the outputting terminal. The third supplier provides a third fluid transmitted to the reaction region of the cell unit via the first connecting port of the cell unit, to humidify the cell unit by the third fluid.

The cell unit further comprises an outer surface, the reaction region comprises a plurality of electrodes exposed on the outer surface, and the second fluid provided by the second supplier passes through the electrodes exposed on the outer surface of the cell unit. The fuel-cell structure comprises a plurality of cell units, a gap is formed between the adjacent cell units, and the second fluid provided by the second supplier transmits to the reaction region of the cell unit by passing through the gap.

The first fluid is hydrogen or methanol. The second supplier is a fan. The second fluid is oxygen or air. The third fluid is water. The water is provided by an external unit.

The reacted cell unit generates water served as the third fluid, and is transmitted to the reaction region of the cell unit via the first connecting port of the cell unit to humidify the cell unit. The third supplier comprises a pump transmitting the third fluid to the reaction region of the cell unit.

The fuel-cell structure further comprises a first controller disposed between the first connecting port of the cell unit and the first supplier to perform flow control of split flow of the first fluid. The first controller is a flow splitter.

The fuel-cell structure further comprises a second controller, and the cell unit further comprises a second connecting port coupled to the reaction region. The second controller is disposed on the second connecting port of the cell unit to perform flow control of a combined flow of the first fluid passing through the cell unit. The second controller is a flow combiner.

The fuel-cell structure further comprises a third controller disposed between the first supplier and the cell unit to perform pressure control of the first fluid. The third controller is a pressure regulator.

The fuel-cell structure further comprises a second controller and a fourth controller, and the cell unit further comprises a second connecting port coupled to the reaction region. The fourth controller disposed at an outlet of the second controller is utilized to perform discharge control of the first fluid passing through the cell unit. The fourth controller is a discharge valve.

The fuel-cell structure further comprises a circuit unit and a power supplier. The cell unit and the power supplier are controlled by the circuit unit, the circuit unit comprises an energy management system, the power supplier controlled by the energy management system provides a second electric power when the cell unit does not provide the first electric power, and the first electric power generated by the cell unit and the second electric power generated by the power supplier do not simultaneously operate. The power supplier is a lithium battery.

The first supplier can comprise a high-pressure hydrogen container, a liquid hydrogen container, a hydrogen storage alloy or a chemical hydrogen substance. The third supplier can supply third fluid capable of mixing with first fluid. The first fluid can be humidified and transmitted.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a perspective view of a fuel-cell structure of the invention;

FIG. 1B is an exploded view of the fuel-cell structure of FIG. 1A;

FIG. 2 is a perspective view of a cell unit of the fuel-cell structure of the invention;

FIG. 3 is a schematic view of a third supplier of the fuel-cell structure of the invention;

FIG. 4 is a schematic view of another third supplier of the fuel-cell structure of the invention; and

FIG. 5 is a flow chart of a humidifying process of the fuel-cell structure of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

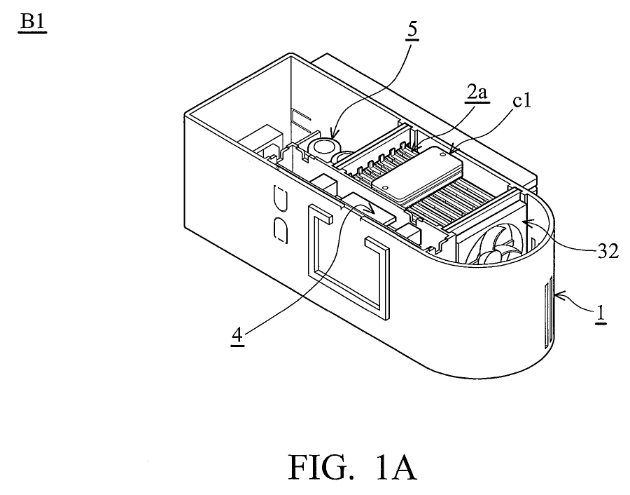

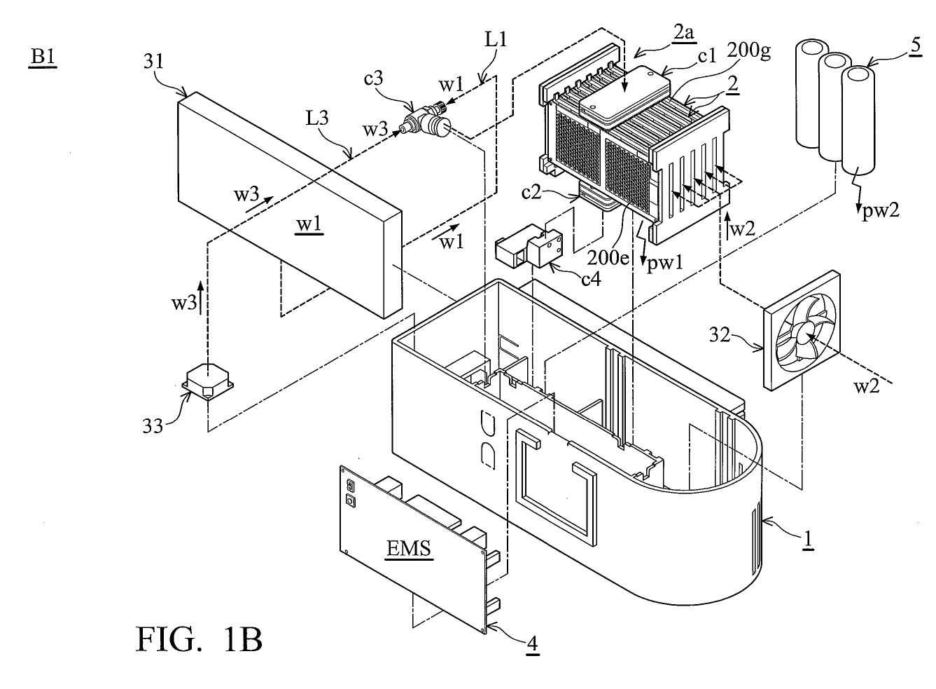

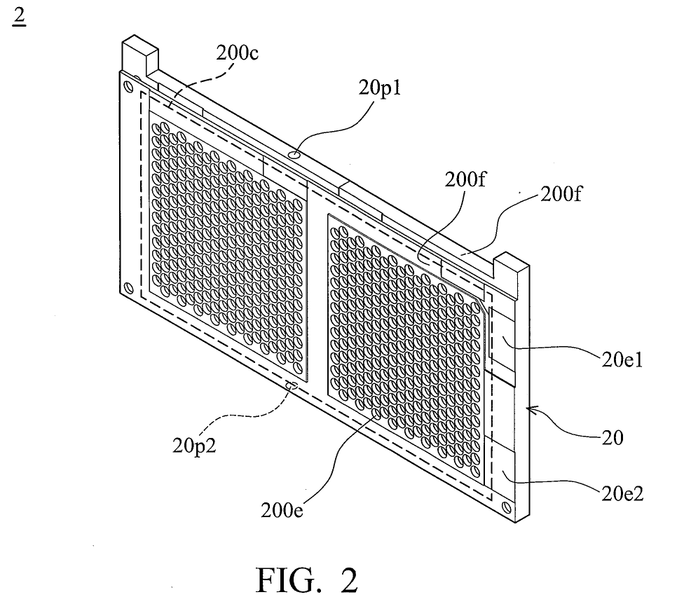

FIGS. 1A and 1B are perspective and exploded views of a fuel-cell structure B1 of an embodiment of the invention, respectively. FIG. 2 is a perspective view of a cell unit 2 of the fuel-cell structure B1.

The fuel-cell structure B1 comprises a base 1, at least one cell unit 2, a first supplier 31, a second supplier 32, a third supplier 33, a circuit unit 4, a power supplier 5, a first controller cl, a second controller c2, a third controller c3 and a fourth controller c4. The cell unit 2, the first supplier 31, the second supplier 32, the third supplier 33, the circuit unit 4, the power supplier 5, the first controller c1, the second controller c2, the third controller c3 and the fourth controller c4 are disposed on the base 1, and the cell unit 2, the first supplier 31, the second supplier 32, the third supplier 33, the power supplier 5, the first controller cl, the second controller c2, the third controller c3 and the fourth controller c4 are controlled by the circuit unit 4. The circuit unit 4 comprises an energy management system EMS.

In this embodiment, the fuel-cell structure B1 comprises a plurality of spaced cell units 2. The cell units 2, the first controller c1 and the second controller c2 constitute a cell module 2a. The first controller c1 is a flow splitter, the second controller c2 is a flow combiner, the third controller c3 is a pressure regulator, and the fourth controller c4 is a discharge valve. A gap 200g is formed between the adjacent cell units 2. The power supplier 5 is a lithium battery or other rechargeable batteries. To briefly describe the structure of the fuel-cell structure B1, the description hereinafter utilizes a single cell unit 2.

The first supplier 31 (e.g., a high-pressure hydrogen container, a liquid hydrogen container, a hydrogen storage alloy or a chemical hydrogen substance) provides a first fluid w1 (e.g., hydrogen or methanol) to the cell module 2a for reaction. The second supplier 32 (e.g., fan) provides a second fluid w2 (e.g., oxygen or air) to the cell module 2a for reaction. The third supplier 33 (e.g., humidifying device) provides a third fluid w3 (e.g., water) to the cell module 2a for humidifying the first fluid w1. The third controller c3 is disposed between the first supplier 31 and the cell unit 2 to perform pressure control of the first fluid w1. Note that the second supplier 32 is a fan (only limited power required) utilized to perform the movement of the second fluid w2 and provide air breathe, instead of a conventional air pump which requires a larger amount of power.

Referring to FIGS. 1B and 2, the cell unit 2 comprises a body 20 having an outer surface 200f, a reaction region 200c, a first connecting port 20p1, a second connecting port 20p2 and outputting terminals 20e1 and 20e2. The first connecting port 20p1, the second connecting port 20p2 and the outputting terminals 20e1 and 20e2 are coupled to the reaction region 200c. The reaction region 200c comprises a plurality of electrodes 200e partially exposed on the outer surface 200f of the body 20 and other reacting elements (e.g., electrolyte, electrolyte membrane, current collector, catalyst and anode). To briefly describe the structure of the cell unit 2, the description related to an electro-chemical reaction is omitted. Note that the first connecting ports 20p1 and the second connecting port 20p2 of the cell units 2 are connected to the first controller c1 and the second controller c2, respectively. The first controller c1 is disposed between the first connecting port 20p1 of the cell unit 2 and the first supplier 31 performs split flow control of the first fluid w1. The second controller c2 is disposed on the second connecting port 20p2 of the cell unit 2 to perform flow control of a combined flow of the first fluid w1 passing through the cell unit 2. The fourth controller c4 disposed at an outlet of the second controller c2 is utilized to perform discharge control of the first fluid w1 passing through the cell unit 2.

The first fluid w1 provided by the first supplier 31 is transmitted to the first controller c1 by traveling along a path L1. After being split by the first controller c1, the split first fluid w1 is transmitted to the reaction region 200c via the first connecting port 20p1 of each cell unit 2. A discharge process is performed by the fourth controller c4 when the pressure of the first fluid w1 inside the fuel-cell structure B1 is greater than a predetermined value.

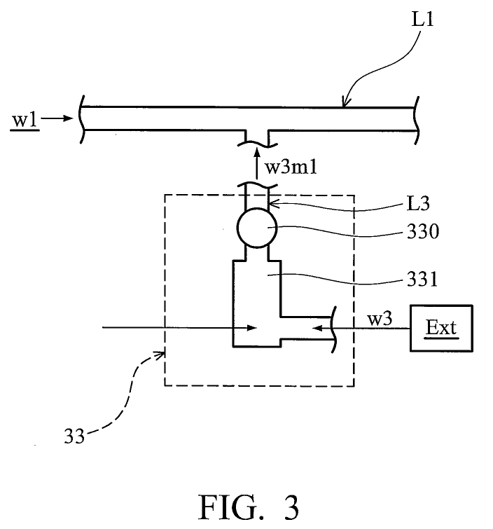

Referring to FIG. 3, the second fluid w2 provided by the second supplier 32 passes through the electrodes 200e exposed on the outer surface 200f of the body 20 via the gaps 200g formed between the adjacent cell units 2. Driven by the reacting elements of the reaction region 200c of the cell unit 2, the reaction of the second fluid w2 and the first fluid w1 are fully performed.

Referring also to FIG. 3, FIG. 3 is a schematic view of a third supplier 33 of the fuel-cell structure B1.

The third supplier 33 is a humidifying device including a pump 330 and a receiving tank 331. A third fluid w3 (e.g. water) is transmitted to the receiving tank 331 by an external unit Ext (e.g., feed water device), and the third fluid w3 received in the receiving tank 331 is transmitted along a path L3 and enters the path L1 by the pump 330 to join with the first fluid w1. Thus, the humidified first fluid w1 transmitted to the reaction region 200c via the first connecting port 20p1 of the cell unit 2 is capable of humidifying the cell units 2 of the cell module 2a.

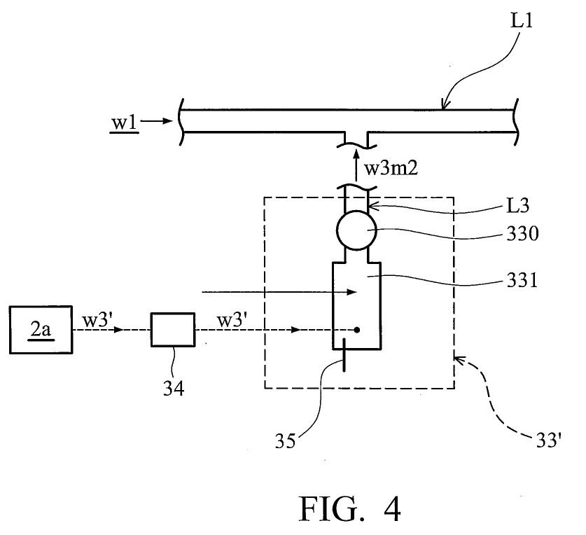

FIG. 4 is a schematic view of another third supplier 33′. The third supplier 33′ differs from the third supplier 33 in that a heater 35 and a thermal-insulating material 34 are further provided, and a fluid w3′ used for entering the receiving tank 331 is water draining from the cell module 2a. Note that the water w3′ is a product of the reactions from the cell module 2a, and the thermal-insulating material 34 is disposed on the path of the water w3′. The heater 35 installed in the receiving tank 331 is utilized to heat the water w3′ received in the receiving tank 331, and the heated water w3′ is converted into a vapor type third fluid w3m2. The vapor type third fluid w3m2 is transmitted along the path L3 enters the path L1 to join with the first fluid w1 by the pump 330. Thus, the humidified first fluid w1 transmitted to the reaction region 200c via the first connecting port 20p1 of the cell unit 2 is capable of humidifying the cell units 2 of the cell module 2a.

The second fluid w2 and the first fluid w1 are reacted within the reaction region 200c of the cell unit 2, so that the reaction region 200c of the cell unit 2 provides a first electric power pw1 outputting through the outputting terminal 20e1 and 20e2.

When the cell unit 2 does not provide the first electric power pw1, the power supplier 5 controlled by the energy management system EMS provides a second electric power pw2. When the energy management system EMS stops supplying the second electric power pw2 provided by the power supplier 5 and commands the cell unit 2 to provide the first electric power pw1, the energy management system EMS is capable of commanding the cell unit 2 to charge the power supplier 5 by the first electric power pw1.

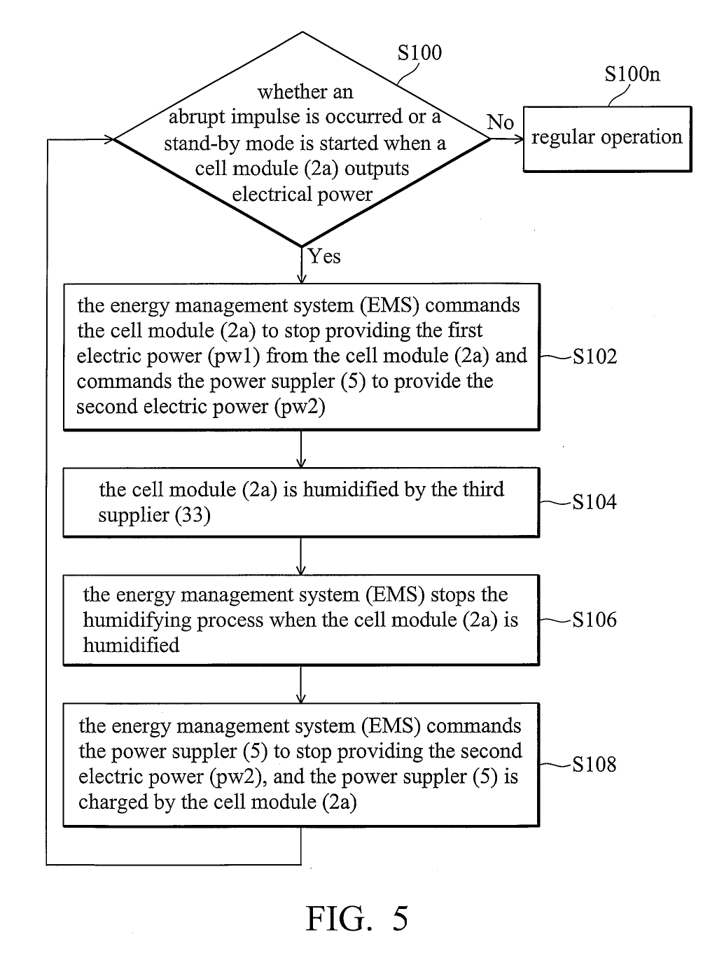

FIG. 5 is a flow chart of a humidifying process of the fuel-cell structure B1. The fuel-cell structure B1 is utilized to provide electric power for electronic devices, such as laptops or mobile phones (not shown). In step S100, during the operation of the electronic device, if an abrupt impulse occurs, a stand-by mode is started by commands issued by a system of the electronic device, or by very low electric power output of the cell module 2a, wherein the energy management system EMS commands the cell module 2a to stop the discharge process, i.e., the cell module 2a stops providing the first electric power pw1 from the cell module 2a (step S102). In step S100n, if the situations described in step S100 do not exist, the electronic device performs a regular operation. In step S102, the energy management system EMS commands the power supplier 5 to continuously provide electric power, i.e., the energy management system EMS controls the power supplier 5 to provide the second electric power pw2. In step S104, the cell module 2a is humidified by the third supplier 33 while the discharge process of the cell module 2a is stopped. In step S106, the energy management system EMS stops the humidifying process when the cell module 2a is humidified. In step S108, the energy management system EMS commands the power supplier 5 to stop providing the second electric power pw2, and the power supplier 5 is charged by the cell module 2a.

With air breathe and planar fuel-cell structure of the embodiment, a humidifying process can be periodically performed, the volume of the fuel-cell structure can be decreased by the planner-stacked cell units thereof, and the rating electric power can be continuously provided for electrical devices or equipment. Further, the fuel-cell structure of the embodiment can be applied by an unplug power-supply system (UPS) or related systems.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel-cell structure, comprising:
a base;
at least one cell unit disposed on the base, comprising a reaction region, a first connecting port and an outputting terminal, wherein the first connecting port and the outputting terminal are coupled to the reaction region;
a first supplier providing a first fluid transmitted to the reaction region of the cell unit via the first connecting port of the cell unit;
a second supplier providing a second fluid transmitted to the reaction region of the cell unit, wherein the second fluid and the first fluid are reacted with respect to the reaction region of the cell unit, so that the reaction region of the cell unit provides a first electric power for outputting through the outputting terminal; and
a third supplier providing a third fluid transmitted to the reaction region of the cell unit via the first connecting port of the cell unit, to humidify the cell unit or the first fluid by the third fluid.

2. The fuel-cell structure as claimed in claim 1, wherein the cell unit further comprises an outer surface, the reaction region comprises a plurality of electrodes exposed on the outer surface, and the second fluid provided by the second supplier passes through the electrodes exposed on the outer surface of the cell unit.

3. The fuel-cell structure as claimed in claim 1, wherein the fuel-cell structure comprises a plurality of cell units, a gap is formed between the adjacent cell units, and the second fluid provided by the second supplier transmits to the reaction region of the cell unit by passing through the gap.

4. The fuel-cell structure as claimed in claim 1, wherein the first fluid comprises hydrogen or methanol.

5. The fuel-cell structure as claimed in claim 1, wherein the second supplier comprises a fan.

6. The fuel-cell structure as claimed in claim 1, wherein the second fluid comprises oxygen or air.

7. The fuel-cell structure as claimed in claim 1, wherein the third fluid comprises water.

8. The fuel-cell structure as claimed in claim 7, wherein the water is provided by an external unit.

9. The fuel-cell structure as claimed in claim 1, wherein the cell unit is reacted to generate water served as the third fluid transmitted to the reaction region of the cell unit via the first connecting port of the cell unit to humidify the cell unit.

10. The fuel-cell structure as claimed in claim 1, wherein the third supplier comprises a pump transmitting the third fluid to the reaction region of the cell unit.

11. The fuel-cell structure as claimed in claim 1 further comprising a first controller disposed between the first connecting port of the cell unit and the first supplier to perform flow control of split flow of the first fluid.

12. The fuel-cell structure as claimed in claim 11, wherein the first controller comprises a flow splitter.

13. The fuel-cell structure as claimed in claim 1 farther comprising a second controller, wherein the cell unit further comprises a second connecting port coupled to the reaction region, and the second controller is disposed on the second connecting port of the cell unit to perform flow control of a combined flow of the first fluid passing through the cell unit.

14. The fuel-cell structure as claimed in claim 13, wherein the second controller comprises a flow combiner.

15. The fuel-cell structure as claimed in claim 1 further comprising a third controller disposed between the first supplier and the cell unit to perform pressure control of the first fluid.

16. The fuel-cell structure as claimed in claim 15, wherein the third controller comprises a pressure regulator.

17. The fuel-cell structure as claimed in claim 1 further comprising a second controller and a fourth controller, wherein the cell unit farther comprises a second connecting port coupled to the reaction region, and the fourth controller disposed at an outlet of the second controller is utilized to perform discharge control of the first fluid passing through the cell unit.

18. The fuel-cell structure as claimed in claim 17, wherein the fourth controller comprises a discharge valve.

19. The fuel-cell structure as claimed in claim 1 further comprising a circuit unit and a power supplier, wherein the cell unit and the power supplier are controlled by the circuit unit, and the circuit unit comprises an energy management system, the power supplier controlled by the energy management system provides a second electric power when the cell unit does not provide the first electric power, and the first electric power generated by the cell unit and the second electric power generated by the power supplier do not simultaneously operate.

20. The fuel-cell structure as claimed in claim 19, wherein the power supplier comprises a lithium battery.

21. The fuel-cell structure as claimed in claim 1, wherein the first supplier comprises high-pressure hydrogen container, a liquid hydrogen container, a hydrogen storage alloy or a chemical hydrogen substance.
